(19) United States
(12) Patent Application Publication
(10) Pub. No.: US 2024/0232916 A1
(43) Pub. Date: Jul. 11, 2024

(54) SYSTEM AND METHOD FOR IMPROVING SURVEY RESPONSE RATE USING SURVEY OUTCAST WINDOW RECOMMENDATION ENGINE

(71) Applicant: NICE LTD., Ra'anana (IL)

(72) Inventors: Pavan LAHOTI, Pune (IN); Sumit VASHISTHA, Pune (IN); Swapnil DISAWAL, Pune (IN)

(21) Appl. No.: 18/152,570

(22) Filed: Jan. 10, 2023

(51) Int. Cl. G06Q 30/0203; G06Q 30/0204

(52) U.S. Cl. CPC G06Q 30/0203; G06Q 30/0205

(57) ABSTRACT

Survey response systems and methods, and non-transitory computer readable media, including receiving, from a customer, a request for a customer survey, wherein the request comprises a plurality of attributes; evaluating each attribute against each feature on a feature importance matrix, wherein the feature importance matrix comprises a ranking of importance of a plurality of features affecting a survey response rate and a recommended time window associated with each feature; matching an attribute to a feature on the feature importance matrix; determining a matched feature having the highest ranked importance on the feature importance matrix; selecting a recommended time window associated with the matched feature having the highest ranked importance; and transmitting the customer survey to the customer in the recommended time window associated with the matched feature having the highest ranked importance to maximize the survey response rate.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems of generating customer survey results, and more particularly to methods and systems that determine the best possible time window to send surveys to maximize survey response rates.

### BACKGROUND

In a contact center, surveys are periodically sent to customers to obtain feedback on products and services. Typically, a system uses predefined survey outcast windows and sends a survey immediately to a customer when the system receives a customer request to trigger the survey. The current systems and methods for doing so, however, leads to lower survey response rates, which leads to degradation of system and product effectiveness and related disadvantages. Typical systems and methods do not include identification of patterns when customers are responding to surveys, and do not include continuous identification of the sample populations that should receive surveys. In some cases, low response rates can lead to a loss of revenue (or missed opportunities for revenue) for system providers, which bill customers based on survey response rates.

Accordingly, a need exists for improved systems and methods that increase the response rate of customer surveys.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified diagram of a system according to embodiments of the present disclosure.

FIG. 2 is a flowchart of a method according to embodiments of the present disclosure.

FIG. 3 illustrates an exemplary user interface used by a customer to select customer attributes for training a machine learning model according to embodiments of the present disclosure.

FIG. 4 illustrates an exemplary output of a machine learning model according to embodiments of the present disclosure.

FIG. 5 illustrates how the random forest algorithm processes data to calculate feature importance according to embodiments of the present disclosure.

FIG. 6 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting-the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting.

One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods provide the best possible time window to send surveys to customers to increase the survey response rate. As used herein, a “customer” is a company or an organization that uses the products and services of the contact center to manage interactions with its clientele. According to one or more embodiments, the present systems and methods use existing historical data and continuous learning of new data sets to predict and output the best time window for sending a survey to a customer (which as used herein may also include potential customers). In various embodiments, the present systems and methods improve survey response rates by using the data of existing survey respondents, and by understanding the patterns in the data such as time of response, customer attributes, and system attributes to generate a machine learning (ML) model that can provide the importance of attributes that have high importance in survey response rates. As used herein, “attributes” refer to a placeholder field used to store customer data. In one embodiment, customer data is received from customers. In various embodiments, the present systems and methods continuously learn from new data and generate a new ML model by comparing the results from the improvement in survey response rates.

In an exemplary embodiment, the present systems and methods rely on identifying patterns from historical data including the time of response, the time the survey invitation is sent, the region from where the survey response is received, and different customer attributes associated with each customer that classifies them into a group based on attributes such as customer type, customer location, or customer influence level. The ML model identifies the importance of each attribute and uses those attributes to send the survey to customers to improve survey response rates. The outcome of the ML model is used to find the recommended time window to send surveys by distributing the surveys per the importance of each attribute. In certain embodiments, the ML model is periodically trained with historical and new data to improve the accuracy and throughput of the survey responses.

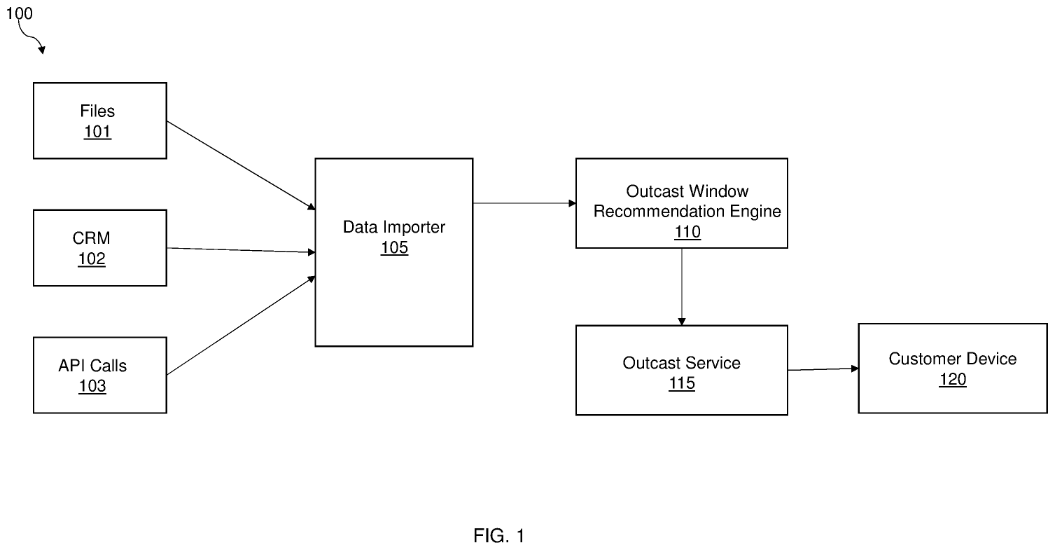

FIG. 1 illustrates a block diagram of a system 100 according to various embodiments of the present disclosure. System 100 includes Files 101, Customer Relationship Management System (CRM) 102, Application Programming Interface (API) Calls 103, Data Importer 105, Outcast Window Recommendation Engine 110, Outcast Service 115, and Customer Device 120. CRM 102 stores customer details such as customer name, address, email, phone number, region, and various other data.

Data gets ingested into System 100 from various sources including Files 101, CRM 102, and API Calls 103. The data from these sources contain the details of customers such as emails, phone numbers, survey responses, and customer attributes. This data is processed by Data Importer 105. Data Importer 105 retrieves customer historical data that is stored in System 100. In one embodiment, Data Importer 105 retrieves data per the defined metadata (i.e., all values for the defined system and custom fields). In various embodiments, the data is labeled with a header row defining the data present in each column.

In some embodiments, Data Importer 105 validates the data for acceptability to ensure required fields are present. For example, if Outcast Service 115 needs to send a web-based survey, then email should be present and a short message service (SMS) survey phone number is required. All of the valid data is then sent to Outcast Window Recommendation Engine 110. “Outcast” as used herein means a process through which a survey can be sent to survey respondents. An “outcast window” as used herein is any time window in which a survey can be sent to survey respondents.

In various embodiments, Outcast Window Recommendation Engine 110 stores the important attributes that are found through a ML process ran on the historical data set present in System 100 from responded surveys. Outcast Window Recommendation Engine 110 then reviews each attribute present in a customer request for a survey, evaluates it against its own feature importance matrix, and distributes the survey such that it can maximize the survey response rate. Outcast Window Recommendation Engine 110 distributes customer surveys based on system attributes such as particular time window and customer attributes such as customer geographical region and other customer attributes provided for the customer. This data is then sent to Outcast Service 115, which sends the customer survey based on the defined outcast window by Outcast Window Recommendation Engine 110. Once the survey is triggered, the survey is received by Customer Device 120 so that the customer can complete the survey. This survey can be in the form of an email invitation, an SMS, or an interactive voice response (IVR) call received on a customer mobile.

In an exemplary method, a customer sends a request for a survey via API Calls 103. Data Importer 105 validates the request and checks that mandatory fields are provided in the request. Once the request is validated, Data Importer 105 forwards the request to Outcast Window Recommendation Engine 110. Outcast Window Recommendation Engine 110 determines and extracts the attributes from the request, evaluates the importance of the attributes to determine the recommended time window, and assigns the outcast window. Outcast Service 115 receives the assigned outcast window, and sends the survey to Customer Device 120 during the assigned outcast window. The customer then receives the survey on Customer Device 120.

To find the best time window, Outcast Recommendation Engine 110 generates a ML model that can be used to identify the best window to send a survey using customer attributes present in the customer request for a survey. To perform model training, Outcast Recommendation Engine 110 gets the historical data from System 100. Data Importer 105 pulls customer attributes and system attributes that can be leveraged during model training and provides these attributes to Outcast Window Recommendation Engine 110. Outcast Window Recommendation Engine 110 takes the data provided by Data Importer 105, cleans the data, and standardizes the activity on the existing data set. This process may include handling missing values from the data, handling of the timestamps, and removal of outlier data. In several embodiments, Outcast Window Recommendation Engine 110 runs an exploratory data analysis (EDA) process to clean up the data. In certain embodiments, this involves deleting all rows having null values, deleting all columns having more than 30% data missing, and standardizing date type columns to a standard format for processing. In several embodiments, all the columns that contain the categorical values are encoded to numerical forms. In one embodiment, Outcast Window Recommendation Engine 110 uses customer attributes and system attributes, and can derive attributes that can be used for model training.

After the data encoding process is performed, the data is split into a training data set and a test data set. The test data set is treated as unseen data in the model evaluation process. The training data set is passed to a ML algorithm, such as a random forest algorithm. The ML algorithm identifies the importance of each attribute against the surveys that are responded to by the customers. In an exemplary embodiment, model training involves continuous processing of data using the random forest algorithm. The outcome of the algorithm evaluation is a model that is evaluated against the test data set for accuracy.

In one or more embodiments, multiple models are generated using hyperparameters defined for the algorithm. The model is retrained using various hyperparameters, and the model with the highest accuracy is chosen for further processing. Once a model is found with the highest accuracy, the model, in one embodiment, is saved as a .H5 file.

From the best model, the feature importance can be determined. A feature list is typically a table containing the attribute and the importance of each attribute. In some embodiments, since the feature list contains all the features (in the present application the features are customer attributes and system attributes), Outcast Window Recommendation Engine 110 only selects the features whose importance is greater than the mean importance of all the features. The best model and the feature list are then stored in a database.

In several embodiments, Outcast Window Recommendation Engine 110 uses the output of the model, which is the feature list, to find the best outcast window to send a customer survey. In various embodiments, Outcast Window Recommendation Engine 110 evaluates the customer request for a survey and determines the best outcast window using the attributes present in the request. In one or more embodiments, Outcast Service 115 then sends the survey to Customer Device 120 only in the assigned outcast window.

In certain embodiments, Outcast Window Recommendation Engine 110 updates the generated ML model using new data that includes customer attributes and system attributes, and stores the updated generated ML model.

In several embodiments, as new data arrives into System 100, Outcast Window Recommendation Engine 110 repeats the EDA process to standardize the new data. The new data is evaluated directly against the saved model to identify attribute importance. If a change in attribute importance is observed, new importance metrics are stored in a database for Outcast Window Recommendation Engine 110, and these new metrics are used in the next evaluation process.

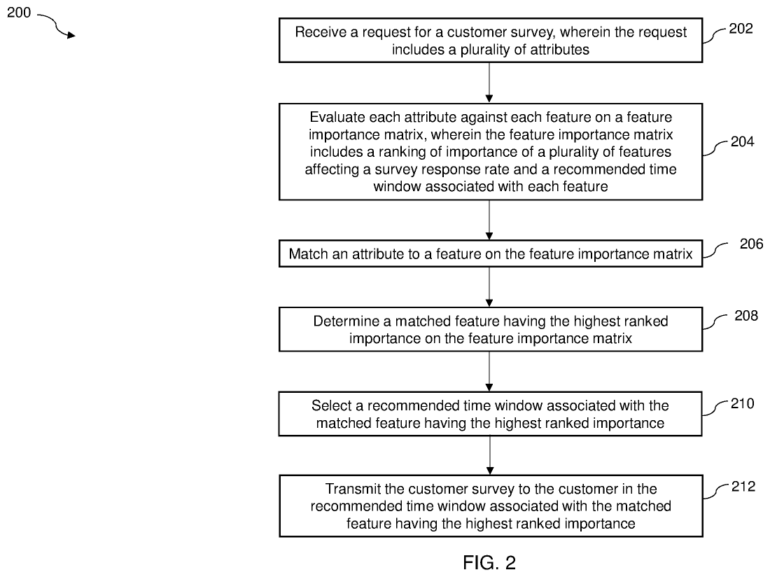

Referring now to FIG. 2, a method 200 according to various embodiments of the present disclosure is described. At step 202, Data Importer 105 receives a request for a customer survey. The request includes a plurality of attributes such as type of customer, a location of a customer, a channel used by a customer, a designation of a customer, an influence level of a customer, or any combination thereof. The request can be in the form of, e.g., an API Call 103 or a file dropped at a Secure File Transfer Protocol (SFTP).

In some embodiments, Data Importer 105 validates the request for mandatory fields and forwards the request to Outcast Window Recommendation Engine 110 if the mandatory fields are present. Data Importer 105 processes the request to determine that the request contains valid information to transmit a customer survey. If the request cannot be further processed, Data Importer 105 moves to the next request. If the request can be further processed, Data Importer 105 sends the request to Outcast Window Recommendation Engine 110.

At step 204, Outcast Window Recommendation Engine 110 evaluates each attribute against each feature on a feature importance matrix. The feature importance matrix includes a ranking of importance of a plurality of features affecting a survey response rate and a recommended time window associated with each feature. Table 1 below is an example of a feature importance matrix. As can be seen, the features in the feature importance matrix correspond to customer attributes such as type of customer or region of the customer.

TABLE 1
FEATURE IMPORTANCE MATRIX

| | | FEATURE |
|---|---|---|
| | | IMPORTANCE |
| | | (1: HIGHEST and |
| Feature | Recommended Window | 6: LOWEST) |
| REGION - US | 9 AM to 12 PM | 1 |
| | (MORNING WINDOW) | |
| CUSTOMER Type - | 10 AM-11 AM | 2 |
| PROMOTER | | |
| REGION - APAC | 1 PM to 3 PM | 3 |
| | (ATERNOON SLOT) | |
| CUSTOMER TYPE - | 4 PM-5 PM | 4 |
| DETRACTOR | | |
| REGION - EMEA | 6 PM to 9 PM | 5 |
| | (EVENING SLOT) | |
| CUSTOMER TYPE - | 7 AM-8 AM | 6 |
| NEUTRAL | | |

At step 206, Outcast Window Recommendation Engine 110, matches an attribute in the request to a feature on the feature importance matrix. At step 208, Outcast Window Recommendation Engine 110, determines a matched feature having the highest ranked importance on the feature importance matrix. At step 210, Outcast Window Recommendation Engine 110, selects a recommended time window associated with the matched feature having the highest ranked importance.

Below in Table 2 are sample input customer requests with attributes of the request. The attributes of the request are matched to the features in Table 1 to find the highest ranked feature in Table 1. Once the highest feature in Table 1 is found, the time window associated with the highest ranked feature is selected as the recommended time window.

TABLE 2
SAMPLE INPUT REQUESTS AND
RECOMMENDED TIME WINDOWS

| | Recommended/Assigned Time |
|---|---|
| Sample Input Request | Window |
| { | 9 AM to 12 PM(MORNING |
| “NAME”: “TEST1”, | WINDOW) |
| “REGION: ”US”, | |
| “EMAIL”: TEST1@TEST.COM” | |
| } | |
| { | 10 AM-11 AM (This window is |
| “NAME”: “TEST2”, | assigned as customer type has higher |
| “REGION: ”APAC”, | feature importance that region |
| “EMAIL”: TEST2@TES2.COM“, | APAC.) |
| “CUSTOMER_TYPE” | |
| :”PROMOTER” | |
| } | |
| { | DO NOT ASSIGN any outcast |
| “NAME”: “TEST3”, | window and send the data |
| “REGION: ”JAPAN”, | immediately as none of the features |
| “EMAIL”: TEST3@TES3.COM”, | match the request data. |
| } | |

Taking the first sample input request, the single attribute of the request is REGION: US, which is the highest ranked feature in the feature importance matrix of Table 1. The recommended time window for this feature is 9 AM to 12 PM (MORNING WINDOW) so this time window is assigned to this first sample input request.

Taking the second sample input request, the attributes of the request are REGION: APAC and CUSTOMER_TYPE: PROMOTER. CUSTOMER_TYPE: PROMOTER is higher ranked than REGION: APAC in the feature importance matrix of Table 1. The recommended time window for CUSTOMER_TYPE: PROMOTER is 10 AM-11 AM so this time window is assigned to the second sample input request.

Taking the third sample input request, the single attribute of the request is REGION: JAPAN. REGION:JAPAN, however, is not found in the feature importance matrix of Table 1. There is no recommended time window for this third sample request, and the survey is sent out immediately.

At step 212, Outcast Service 115 transmits the customer survey to Customer Device 120 in the recommended time window associated with the matched feature having the highest ranked importance. In the above examples, the customer survey for the first sample input request would be sent between 9 AM to 12 PM, and the customer survey for the second sample input request would be sent between 10 AM to 11 AM.

Below is an example that illustrates the present methods in more detail. Data Importer 105 receives customer data to initiate a survey. The sample API request is as follows:

```
{
  “name” : “ABCD”,
  “surveyIdfier” : “SURVEY_123”,
  “customerType: “Premium”,
  “region” : “US”
  “email”: “abc@xyz.com”
}
```

The “name” attribute represents a field that can store a customer name. The “surveyIDfier” attribute represents a unique identifier of a survey that can be sent to a customer. The “email” attribute represents a field that can store a customer email address. The “customerType” attribute represents a customer grouping in a certain category based on the customer's value to the company such as premium, gold, or standard. The “region” attribute represents a region to which the customer belongs.

Data Importer 105 then runs business rule validations to ensure that the mandatory attributes of “email” and “survey IDfier” are present in the API request.

```
For field present in API Request
  If mandatory fields missing
    Return “Error”
  Else
    “Validation Pass - Survey can be Sent”
```

Data Importer 105 determines that the API request includes the mandatory fields, and passes the API request to Outcast Window Recommendation Engine 110. Outcast Window Recommendation Engine 110, retrieves the feature importance matrix that was created by evaluation of a ML model. The feature importance matrix used in this example is provided below.

TABLE 3
EXAMPLE FEATURE IMPORTANCE MATRIX

| | | | Outcast | Outcast |
|---|---|---|---|---|
| Feature | Value | Importance | Window | Window ID |
| customerType | Premium | 1 | 9 AM-10 AM | 1 |
| Region | US | 2 | 10 AM-12 PM | 2 |

Outcast Window Recommendation Engine 110, then determines the best outcast window to send the survey to the customer based on comparison of the attributes of the API request to the features in the feature importance matrix of Table 3. If the attributes in the API request are found in the feature importance matrix, Outcast Recommendation Engine 110, finds the associated or corresponding outcast window and stores the outcast window. In some embodiments, the outcast windows are then sorted by importance, and the most important outcast window ID is assigned to the API request if it is still available. If not, the next outcast window ID is assigned.

Step 1:

For Each field in API Request

If field found in Best Window matrix Find the outcast window and store in

Found_Time_Windows Else if Not found Move to next field

Step 2:

For Each value in SORT(Found_Time_Windows) By Importance If Window is available Assign the outcast window ID Else Time Window has passed Move to next window

Outcast Window Recommendation Engine 110, then sends the assigned time window to Outcast Service 115, which sends the survey according to the assigned time window. If the assigned time window is present, the survey is queued to be sent in that time window. If no time window is present, the survey is sent immediately.

In various embodiments, Outcast Window Recommendation Engine 110, generates a ML model that identifies an importance of one or more features affecting the survey response rate, and derives the feature importance matrix from the identified importance of features affecting the survey response rate.

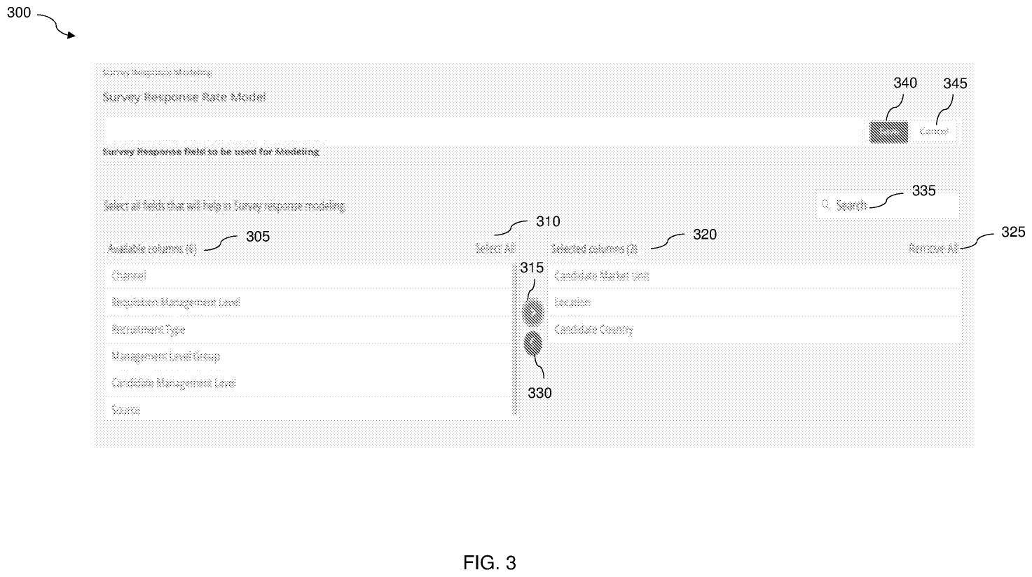

In some embodiments, Outcast Window Recommendation Engine 110, receives, from the customer (i.e., a user of System 100), a list of the customer attributes to be used in determining the feature importance score for each of the customer attributes. FIG. 3 illustrates an exemplary user interface 300 that may be used by a customer to select customer attributes for training the ML model. Using this user interface 300, customers can select and save the attributes to be used for model training. The user interface 300 includes all the predefined customer attributes present in the system, and also shows the total number of available customer attributes 305 present in the system. A customer can click on the individual attributes in the left grid to select or deselect a customer attribute. There is also an option 310 to select all to mark all the customer attributes in the left grid for selection. Once the customer attributes are selected, customers can use the arrow 315 to move the attributes to the selected grid 320. Attributes present in the selected grid 320 can be deselected by clicking on individual attributes or using the option 325 to remove all. A customer can also use arrow 330 to move selected attributes back to the available grid 305. A customer can also see the number of selected attributes for the selected grid 320. A customer may also use the search option 335 to identify any attribute present in the selected columns list 320 or available columns list 305. Once a customer has finalized his/her selection of attributes, the customer can choose the save option 340 to save his/her selection or the customer can use the cancel option 345 to reset his/her selection.

In certain embodiments, generating the ML model includes retrieving historical data including customer attributes and system attributes, and inputting the historical data into a random forest algorithm to create a plurality of ML models. Each ML model predicts a feature importance score for each of the customer attributes and each of the system attributes affecting the survey response rate. In one or more embodiments, the customer attributes include a type of customer, a location of a customer, a channel used by a customer, a designation of a customer, an influence level of a customer, or any combination thereof. In certain embodiments, the system attributes include a time of survey response, a time when a survey invitation was sent, a geographical response pattern, a country or a region response pattern, or any combination thereof.

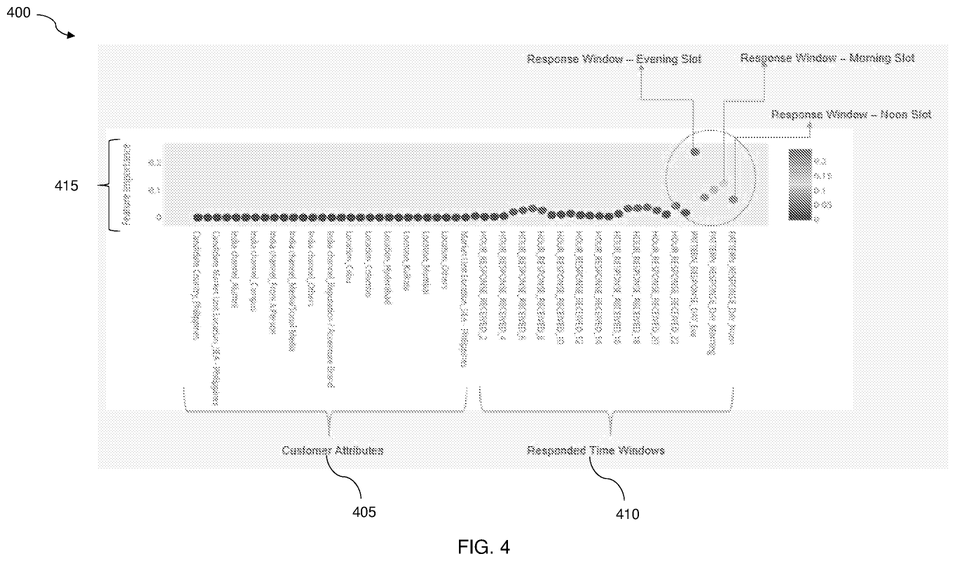

Referring now to FIG. 4, show is an exemplary output 400 of a ML model according to various embodiments. Output 400 of the ML model shows the attributes having the highest importance in survey responses. As shown, output 400 includes customer attributes 405 selected by customers and system attributes such as the time slices 410 customers responded to surveys in the past. The time slices 410 provide the time window where customers are responding. The importance of each attribute 415 is also displayed.

In the example of FIG. 4, the customer attributes all belong to the same attribute of location or region of SOUTH/SOUTHEAST ASIA. The time window having the highest feature importance is the evening slot. Therefore, in the feature importance matrix, for the feature of REGION: SOUTH/SOUTHEAST ASIA, the recommended time window would be the evening time slot (e.g., 6 PM to 9 PM).

In one or more embodiments, deriving the feature importance matrix includes sorting the feature importance scores of the customer attributes and the system attributes, selecting the customer attributes and/or system attributes having a feature importance score greater than a mean feature importance score, and evaluating the selected customer feature attributes and/or system feature attributes against a plurality of time windows to determine an optimum time window to send a survey to improve the survey response rate. In various embodiments, the customer feature attributes, system feature attributes, and/or time windows are subsequently ranked based on their respective feature importance score obtained from the output of the ML model.

Each ML model generated is tested for accuracy using a test data set to create an ML model accuracy ranking. The accuracies of the different ML models are compared, and the ML model with the highest ranked accuracy is selected. This ML model with the highest ranked accuracy is then stored, and used in subsequent evaluations.

In an exemplary embodiment, the random forest algorithm is used to train the ML model. The random forest algorithm is a supervised ML algorithm that is widely used in classification and regression problems. It builds decision trees on different samples, and evaluates the importance of features in a model. The random forest algorithm comes with a feature importance element that outputs an array containing a value between 0 and 100 for each feature that represents how useful the model found each feature in trying to predict the target. This provides the opportunity to analyze what contributed to the accuracy of the model and what features were just noise.

In the present application, the target to be predicted is “the customer responded to the survey,” and the “features” are the customer attributes and the system attributes. When a customer request for a survey is received, the most important attributes of the request are predicted based on the model, and the attributes having the highest importance in affecting the survey response rates are selected.

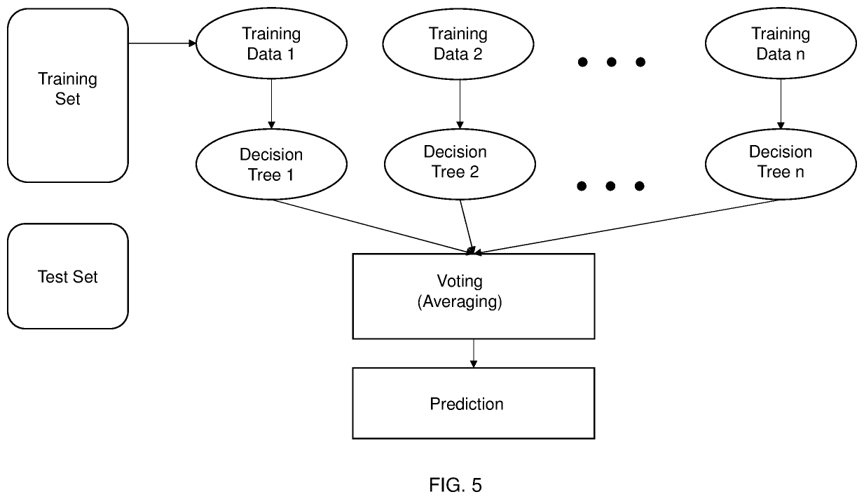

FIG. 5 shows how the random forest algorithm internally processes data to calculate feature importance. For each decision tree, a node's importance is determined using Gini importance (or mean decrease impurity), which is computed from the random forest structure. Assuming only two child nodes (binary tree):

$${ni}_{j} = {w}_{j} {C}_{j} - {w}_{left ( j )} {C}_{left ( j )} - {w}_{right ( j )} {C}_{right ( j )}$$

where: niⱼ=the importance of node j wⱼ=weighted number of samples reaching node j Cⱼ=the impurity value of node j leftⱼ=child node from left split on node j rightⱼ=child node from right split on node j

The importance of each feature on a decision tree is then calculated as:

$${fi}_{i} = \frac{{\sum }_{j : node j splits on feature i} {ni}_{j}}{{\sum }_{k ∈ all nodes} {ni}_{k}}$$

where: f1ᵢ=the importance of feature i niⱼ=the importance of node j

These can then be normalized to a value between 0 and 1 by dividing by the sum of all feature importance values:

$$norm {fi}_{i} = \frac{{fi}_{i}}{{\sum }_{j ∈ all features} {fi}_{j}}$$

The final feature importance, at the random forest level, is its average over all the trees. The sum of the feature's importance value on each tree is calculated and divided by the total number of trees:

$${RFfi}_{i} = \frac{{\sum }_{j ∈ all trees} norm {fi}_{ij}}{T}$$

where: RFf1ᵢ=the importance of feature i calculated from all trees in the random forest model normfiᵢⱼ=the normalized feature importance for i in tree j T=total number of trees

Below is a detailed explanation of the data structures that are input into the ML algorithm (e.g., the random forest algorithm), the data structure processing, and applying the feature importance matrix to determine the survey outcast window.

Input Data Structure for the ML Algorithm input_custom_field=CustomField1, CustomField2, CustomField3.. . . , CustomFieldN, RESPONSE_ID input_system_field=SystemField1, SystemField2, SystemField3, . . . , SystemFieldN, RespondedYN, CreatedTimeStamp, ‘Invitation Sent Date’, Response_ID

CustomField1 . . . N denotes the fields selected on the user interface (see FIG. 3) for model learning. SystemField1 . . . N denotes predefined fields that not do not vary with other customers and identified customer location, type of customer, region, state, or country. CreatedTimeStamp is a field that identifies when the survey respondents responded to the survey. InvitationSent Date is a field that identifies when the survey invitation was sent to customers. Response_ID is a unique field that is present for each survey response in the system, and RespondedYN is a field that identifies if the customer responded to the survey or not.

Data Structure Processing

The below steps are followed to process the data structure. First, the commas are converted to separate fields in each data frame. Null values are then removed. The two data frames are merged using join columns as Response_ID. The timestamp columns are then processed to a standard date format.

df[‘INVITATION_SENT_DATE’]=pd.to_datetime(df[‘Invitation Sent Date’], format=‘%Y-%m-%d %H:%M’).

Derived columns are generated using ‘INVITATION_SENT_DATE’ for each hour. One hot encoding is then performed for categorial columns or columns that have string type values. For the column “JOB_TYPE” the categorical value is converted to a numerical encoded value. #df[‘Job Type’]=label_encoder.fit_transform(df[‘Job Type’]).

Next, the training part of the first sequence is generated. X=df.filter[(<List of columns from the step above>)] y=df.filter[(‘RespondedYN’)].

The test data and training data are then split. X_train, X_test, y_train, y_test=train_test_split(X, y, train_size=0.7, test_size=0.3, random_state=100) X_train: The training part of the first sequence (X) X_test: The test part of the first sequence (X) y_train: The training part of the second sequence (y) y_test: The test part of the second sequence (y)

The algorithm can now be initialized. rf=Random ForestClassifier(random_state=42, n_jobs=−1)

The hyperparameters are initialized. The hyperparameters are not parameters that are externally applied to the algorithm to improve the accuracy of the algorithm. Possible hyperparameters include the number of estimators and the depth of the tree. In an exemplary embodiment, the hyperparameters include a number of trees the random forest algorithm builds before averaging predictions, a maximum number of features considered by the random forest algorithm before splitting a node, and a minimum number of leaves required to split an internal node.

```
params = {
  ‘max_depth’: [2,3,5,10,20],
  ‘min_samples_leaf ’: [5,10,20,50,100,200],
  ‘n_estimators’: [10,25,50,100]
}
```

N_estimators are the number of trees the algorithm builds before averaging the predictions. Max_features is the maximum number of features the random forest considers before splitting a node. Min_samples_leaf determines the minimum number of leaves required to split an internal node.

Exhaustive model learning using GridSearchCV is subsequently performed. GridSearchCV is a technique to search through the best parameter values from the given set of the grid of parameters.

```
grid_search = GridSearchCV(estimator=rf,
  param_grid=params,
  cv = 4,
  n_jobs= −1, verbose=1, scoring=“accuracy”)
```

The mode that will execute the model training process over the defined hyperparameters is fitted. grid_search.fit(X_train, y_train)

The best model can be found using the estimator function available with gridsearch.

```
  rf_best = grid_search.best_estimator_{—}
  rf_best
      RandomForestClassifier
RandomForestClassifier(max_depth=20, min_samples_leaf=5,
    n_estimators=50, n_jobs= −1, random_state=42)
```

The feature importance results from the best estimator are stored.

```
    imp_df = pd.DataFrame({
  “Varname”: X_train.columns,
  “Imp”: rf_best.feature_importances_{—}
})
```

The model and the feature importance results are stored in a database.

Applying the Feature Importance Matrix on Survey Outcast Window When a customer survey request is received, the sample data structure for the API call is determined.

```
{
  “Region”:”APAC”,
  “CustomerType”,”Premium”
  “SurveyName”:”Transactional Survey 1”
  “CustomerEmail”:”abc@xyz.com”,
  “CustomField1”:”Value1”,
  “CustomField2”:”Value2”
  ................................
  ................................
  “CustomeFieldN”:”ValueN”
}
```

The API payload is sent to Outcast Window Recommendation Engine 110. Outcast Window Recommendation Engine 110, evaluates each field received in the payload and assigns an outcast window to send the data per the importance present in the feature importance matrix. If multiple features are present, Outcast Window Recommendation Engine 110, uses the feature with the highest importance in the feature importance matrix. If none of the attributes of the payload are found in the feature importance matrix, then the invitation to the survey is sent immediately.

In some embodiments, if none of the attributes are found, the outcast window having the highest importance is assigned. This could happen if an attribute assigned to the current payload is removed from the model when only features that have an importance greater than the mean importance of all features are selected. In one or more embodiments, only those attributes with a feature importance score greater than the mean feature importance score of all the attributes are selected for inclusion in the feature importance matrix.

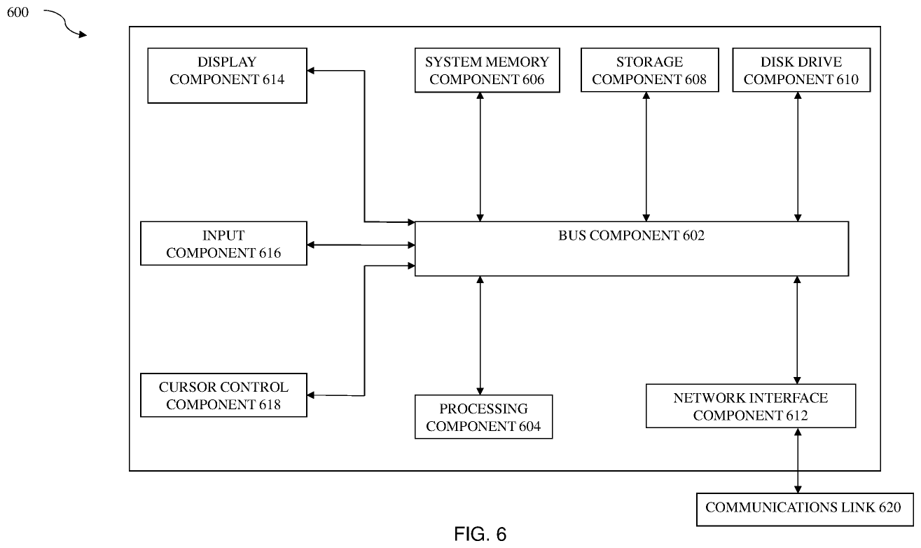

Referring now to FIG. 6, illustrated is a block diagram of a system 600 suitable for implementing embodiments of the present disclosure. System 600, such as part of a computer and/or a network server, includes a bus 602 or other communication mechanism for communicating information, which interconnects subsystems and components, including one or more of a processing component 604 (e.g., processor, micro-controller, digital signal processor (DSP), etc.), a system memory component 606 (e.g., RAM), a static storage component 608 (e.g., ROM), a network interface component 612, a display component 614 (or alternatively, an interface to an external display), an input component 616 (e.g., keypad or keyboard), and a cursor control component 618 (e.g., a mouse pad).

In accordance with embodiments of the present disclosure, system 600 performs specific operations by processor 604 executing one or more sequences of one or more instructions contained in system memory component 606. Such instructions may be read into system memory component 606 from another computer readable medium, such as static storage component 608. These may include instructions to receive, from a customer, a request for a customer survey, wherein the request comprises a plurality of attributes; evaluate each attribute against each feature on a feature importance matrix, wherein the feature importance matrix comprises a ranking of importance of a plurality of features affecting a survey response rate and a recommended time window associated with each feature; match an attribute to a feature on the feature importance matrix; determine a matched feature having the highest ranked importance on the feature importance matrix; select a recommended time window associated with the matched feature having the highest ranked importance; and transmit the customer survey to the customer in the recommended time window associated with the matched feature having the highest ranked importance to maximize the survey response rate. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 604 for execution. Such a medium may take many forms, including but not limited to, non-volatile media, volatile media, and transmission media. In various implementations, volatile media includes dynamic memory, such as system memory component 606, and transmission media includes coaxial cables, copper wire, and fiber optics, including wires that comprise bus 602. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 600. In various other embodiments, a plurality of systems 600 coupled by communication link 620 (e.g., LAN, WLAN, PTSN, or various other wired or wireless networks) may perform instruction sequences to practice the disclosure in coordination with one another. Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A survey response system comprising:
a processor and a non-transitory computer readable medium operably coupled thereto, the computer readable medium comprising a plurality of instructions stored in association therewith that are accessible to, and executable by, the processor, to perform operations which comprise:
receiving, from a customer, a request for a customer survey, wherein the request comprises a plurality of attributes;
evaluating each attribute against each feature on a feature importance matrix, wherein the feature importance matrix comprises a ranking of importance of a plurality of features affecting a survey response rate and a recommended time window associated with each feature;
matching an attribute to a feature on the feature importance matrix;
determining a matched feature having the highest ranked importance on the feature importance matrix;
selecting a recommended time window associated with the matched feature having the highest ranked importance; and
transmitting the customer survey to the customer in the recommended time window associated with the matched feature having the highest ranked importance to maximize the survey response rate.

2. The survey response system of claim 1, wherein the operations further comprise:
generating a machine learning (ML) model that identifies an importance of one or more features affecting the survey response rate; and
deriving the feature importance matrix from the identified importance of features affecting the survey response rate.

3. The survey response system of claim 2, wherein generating the ML model comprises:
retrieving historical data comprising customer attributes and system attributes;
inputting the historical data into a random forest algorithm to create a plurality of ML models, wherein each ML model predicts a feature importance score for each of the customer attributes and each of the system attributes affecting the survey response rate;
testing an accuracy of each ML model to create an ML model accuracy ranking;
selecting the ML model with the highest ranked accuracy; and
storing the ML model with the highest ranked accuracy.

4. The survey response system of claim 3, wherein deriving the feature importance matrix from the identified importance of features affecting the survey response rate comprises:
sorting the feature importance scores of the customer attributes and the system attributes;
selecting the customer attributes and/or system attributes having a feature importance score greater than a mean feature importance score; and
evaluating the selected customer feature attributes and/or system feature attributes against a plurality of time windows to determine an optimum time window to send a survey to improve the survey response rate.

5. The survey response system of claim 3, wherein:
the customer attributes comprise a type of customer, a location of a customer, a channel used by a customer, a designation of a customer, an influence level of a customer, or any combination thereof, and
the system attributes comprise a time of survey response, a time when a survey invitation was sent, a geographical response pattern, a country or a region response pattern, or any combination thereof.

6. The survey response system of claim 3, wherein the operations further comprise receiving, from the customer, a list of the customer attributes to be used in determining the feature importance score for each of the customer attributes.

7. The survey response system of claim 3, wherein inputting the historical data into a random forest algorithm to create a plurality of ML models comprises using hyperparameters of the random forest algorithm, the hyperparameters comprising a number of trees the random forest algorithm builds before averaging predictions, a maximum number of features considered by the random forest algorithm before splitting a node, and a minimum number of leaves required to split an internal node.

8. The survey response system of claim 2, wherein the operations further comprise:
updating the generated ML model using new data comprising customer attributes and system attributes; and
storing the updated generated ML model.

9. The survey response system of claim 1, wherein the operations further comprise processing the request to determine that the request contains valid information to transmit a customer survey.

10. A method for improving a survey response rate, which comprises:
receiving, from a customer, a request for a customer survey, wherein the request comprises a plurality of attributes;
evaluating each attribute against each feature on a feature importance matrix, wherein the feature importance matrix comprises a ranking of importance of a plurality of features affecting the survey response rate and a recommended time window associated with each feature;
matching an attribute to a feature on the feature importance matrix;
determining a matched feature having the highest ranked importance on the feature importance matrix;
selecting a recommended time window associated with the matched feature having the highest ranked importance; and
transmitting the customer survey to the customer in the recommended time window associated with the matched feature having the highest ranked importance to maximize the survey response rate.

11. The method of claim 10, which further comprises:
generating a machine learning (ML) model that identifies an importance of one or more features affecting the survey response rate; and
deriving the feature importance matrix from the identified importance of features affecting the survey response rate.

12. The method of claim 11, wherein generating the ML model comprises:
retrieving historical data comprising customer attributes and system attributes;
inputting the historical data into a random forest algorithm to create a plurality of ML models, wherein each ML model predicts a feature importance score for each of the customer attributes and each of the system attributes affecting the survey response rate;
testing an accuracy of each ML model to create an ML model accuracy ranking;
selecting the ML model with the highest ranked accuracy; and
storing the ML model with the highest ranked accuracy.

13. The method of claim 12, wherein deriving the feature importance matrix from the identified importance of features affecting the survey response rate comprises:
sorting the feature importance scores of the customer attributes and the system attributes;
selecting the customer attributes and/or system attributes having a feature importance score greater than a mean feature importance score; and
evaluating the selected customer feature attributes and/or system feature attributes against a plurality of time windows to determine an optimum time window to send a survey to improve the survey response rate.

14. The method of claim 12, wherein:
the customer attributes comprise a type of customer, a location of a customer, a channel used by a customer, a designation of a customer, an influence level of a customer, or any combination thereof, and
the system attributes comprise a time of survey response, a time when a survey invitation was sent, a geographical response pattern, a country or a region response pattern, or any combination thereof.

15. The method of claim 12, which further comprises receiving, from the customer, a list of the customer attributes to be used in determining a feature importance score for each of the customer attributes.

16. A non-transitory computer-readable medium having stored thereon computer-readable instructions executable by a processor to perform operations which comprise:
receiving, from a customer, a request for a customer survey, wherein the request comprises a plurality of attributes;
evaluating each attribute against each feature on a feature importance matrix, wherein the feature importance matrix comprises a ranking of importance of a plurality of features affecting a survey response rate and a recommended time window associated with each feature;
matching an attribute to a feature on the feature importance matrix;
determining a matched feature having the highest ranked importance on the feature importance matrix;
selecting a recommended time window associated with the matched feature having the highest ranked importance; and
transmitting the customer survey to the customer in the recommended time window associated with the matched feature having the highest ranked importance to maximize the survey response rate.

17. The non-transitory computer-readable medium of claim 16, wherein the operations further comprise:
generating a machine learning (ML) model that identifies an importance of one or more features affecting the survey response rate; and
deriving the feature importance matrix from the identified importance of features affecting the survey response rate.

18. The non-transitory computer-readable medium of claim 17, wherein generating the ML model comprises:
retrieving historical data comprising customer attributes and system attributes;
inputting the historical data into a random forest algorithm to create a plurality of ML models, wherein each ML model predicts a feature importance score for each of the customer attributes and each of the system attributes affecting the survey response rate;
testing an accuracy of each ML model to create an ML model accuracy ranking;
selecting the ML model with the highest ranked accuracy; and
storing the ML model with the highest ranked accuracy.

19. The non-transitory computer-readable medium of claim 18, wherein deriving the feature importance matrix from the identified importance of features affecting the survey response rate comprises:
sorting the feature importance scores of the customer attributes and the system attributes;
selecting the customer attributes and/or system attributes having a feature importance score greater than a mean feature importance score; and
evaluating the selected customer feature attributes and/or system feature attributes against a plurality of time windows to determine an optimum time window to send a survey to improve the survey response rate.

20. The non-transitory computer-readable medium of claim 18, wherein:
the customer attributes comprise a type of customer, a location of a customer, a channel used by a customer, a designation of a customer, an influence level of a customer, or any combination thereof, and
the system attributes comprise a time of survey response, a time when a survey invitation was sent, a geographical response pattern, a country or a region response pattern, or any combination thereof.
